(19) United States
(12) Patent Application Publication
(10) Pub. No.: US 2008/0209131 A1
(43) Pub. Date: Aug. 28, 2008

(54) STRUCTURES, SYSTEMS AND ARRANGEMENTS FOR CACHE MANAGEMENT

(76) Inventors: Marcus L. Kornegay, Durham, NC (US); Ngan N. Pham, Raleigh, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/112,910

(22) Filed: Apr. 30, 2008

Related U.S. Application Data
(63) Continuation-in-part of application No. 11/562,562, filed on Nov. 22, 2006.

(51) Int. Cl. G06F 12/08

(52) U.S. Cl. 711/135; 711/E12.022

(57) ABSTRACT

A design structure embodied in a machine readable storage medium for designing, manufacturing, and/or testing a design is provided. The design structure generally includes a processing system. The process system generally includes a processor, cache coupled to the processor to provide at least one line of binary storage to the processor module, an eviction management module coupled to the processor to monitor lines of code interacting with the cache and to count storage related occurrences of the lines of code with respect to the cache, the lines of code having an identifier, and a cache directory to store the count and the identifier, wherein if processor requests cache capacity, the cache directory provides eviction related data for a line of code stored in the cache to the processor.

### CROSS-REFERENCE TO RELATED APPLICATION

This application is a continuation-in-part of co-pending U.S. patent application Ser. No. 11/562,562, filed Nov. 22, 2006, which is herein incorporated by reference.

### BACKGROUND OF INVENTION

### Field of Invention

The present disclosure is generally related to design structures, and more specifically, design structures in the field of processors and particularly to management of cache memory contents associated with processors.

Most modern computer systems include some form of a processor and smaller computer systems typically utilize a microprocessor. In operation, a processor will typically retrieve instructions from memory and execute the instructions to process data. The majority of memory within a modern computer system is typically relatively large, and thus due to design requirements the majority of memory is nearly always physically located external to the integrated circuit that contains the processor. Thus, a processor will move data about the computer system, storing and retrieving data from memory when needed. More particularly, the processor can read data from main memory and write data to main or system memory that is external to the processor according to operating instructions.

Transfer of data between the processor and external memory is relatively slow compared to the speed at which the microprocessor can perform data processing internally. Consequently, the processor may be idle waiting for data to be retrieved from memory or waiting for data to be written to the memory. When a lot of data is being transferred, say from one location to another in the system, processor idle time can occur during the majority of clock cycles. In systems with large read and write delay times, the processor and other system resources can be idle over half of the time. Such inefficiencies are generally unacceptable and consumer demands dictate that computer system designs address such inefficiencies.

To reduce such inefficiencies, modern processors often incorporate cache memory. Cache memory, or cache, is memory co-located with the processor. Cache provides access delays, or read and write times that are a fraction of the delay times associated with accessing main, system or external memory. Cache can provide such quick access times due to high performance components and sophisticated designs and due to cache's close proximity to the core of the processor. However, cache is relatively small and typically can only store a small fraction of what can be stored in main memory. Cache is typically utilized to temporarily store subsets of the instructions or data that have been retrieved from system memory or other memory systems. Generally, cache stores data or instructions in cache lines. A cache line is the smallest unit of data than can be transferred between the cache and the system memory. Today, typical cache lines are 32 bits wide however, current state-of-the-art cache systems have evolved to 64 bit lines.

When a processor executes an instruction that requests data or an instruction, the processor can first check to see if the requested line is already cache and if such a line is valid, (data can become invalid). If a valid line is found in cache, the instruction can be executed immediately since the line can be quickly retrieved from cache. Accordingly, when this occurs during a read, or load instruction, the processor does not have to wait until the data is fetched from system memory and received at the processor, saving valuable time. Similarly, in the case of a write or store operation, the processor can write the data to cache and proceed on, instead of having to wait until the data is successfully written to memory a relatively long distance away again saving valuable time.

The condition where the processor successfully determines that a requested cache line containing the data or instruction is present in cache and valid, is commonly referred to as a cache hit, or hit. The condition where the processor detects that the requested cache line is not present or is invalid is commonly referred to as a cache miss, or miss. When a cache miss occurs, the cache may notify other functional blocks within the processor that the miss has occurred so that the missing cache line can be fetched from system memory and placed into cache. In traditional cases, the cache may not immediately notify the other functional block that the miss has occurred and may opt to send instruction to memory for retrieval of the requested line, again sacrificing valuable processor time.

A system with 64 bit wide cache lines has a significantly larger “footprint” or much more code data than the smaller, legacy 32 bit environments. This increase in the amount of code data required for processor operation puts more pressure on 64 bit cache systems that have not grown proportionally with the 64 bit core processor, and the result of this change is more frequent eviction of cache lines in such systems. The increased frequency of evictions occurs due to capacity conflicts or the lack of cache capacity because generally, the number of bits available in a cache has not been increased (doubled) while bus lines that accommodate instructions or data lines have doubled in size (i.e. from 32 bits to 64 bits). Often, many levels of cache exist and lines can be moved from high level cache to last level cache before cache lines are flushed or evicted based on cache conflicts or cache management procedures. Thus, 64 bit cache lines are more frequently evicted or cast out from the last-level cache (LLC) than the 32 bit cache lines.

This higher rate of cache evictions associated with 64 bit cache systems significantly increases the cache miss rate (or miss per instruction). As stated above, when a miss occurs, the processor must fetch data/code lines from main or system memory sacrificing valuable time. This loss of time occurs because often, the line of code/data desired by the processor has been evicted in previous clock cycles due to capacity conflicts. The resulting retrieval from non-cache memory systems will cause a relatively long idle period for the processor and other system components and this cache miss rates significantly degrades system efficiency.

This decreased efficiency leads to secondary issues such as increased power consumption, increased bus traffic, and generally degradation of overall system performance. Many cache management systems and methods have been disclosed because of the on-going need for better management of cache memory. Most 64 bit processor architectures simply accept the increase in cache misses as an uncorrectable phenomenon, even though significant system degradation can be attributed to such failure to mange. Many cache architectures are available to implement certain cache eviction priority schemes. Some of these schemes include a least frequently used (LFU) technology or least recently used (LRU) technology.

Generally, a LFU system is a cache entry-expiry strategy. On a cache miss, the least frequently used line or record is discarded from cache to be replaced by the requested line that caused the cache miss. While this approach leads to very efficient utilization of the cache's capacity, it requires complex overhead processes and hardware. The overhead incurred is rarely worth the effort required and only pays off if cache misses are many orders of magnitude more expensive than a cache hit. Even hard disk caches where the disparity between hit and miss is a factor of about 1,000, LFU topologies may not achieve significantly better performance than LRU topologies.

In a LRU topology, newly retrieved lines and cache retrieved lines are placed at the top of the cache and pushed down the stack with subsequent entries. Thus, when the cache grows past its size limit, a LRU topology throws away items off the bottom of the cache which have been “used less recently.” Thus, whenever a line of cache is accessed, it is moved back to the top of the cache stack such that the line that has not been utilized for the longest time can be identified and flushed. This way all lines in cache that are “re-accessed” or frequently accessed will to stay in cache. LFU and LRU technologies have many known problems and are less than perfect and thus an improved system and method for improving cache management would be desirable.

### SUMMARY OF THE INVENTION

The problems identified above are in large part addressed by the apparatuses systems, methods, and arrangements disclosed herein to reduce the frequency of cache reloads by tracking the number of times that a particular line of cache has been evicted from cache or alternately has been reloaded into cache. The lines currently in cache can be ranked based on how many times the line has been evicted from cache. When additional cache capacity is required, the lines in cache that have never been evicted or have been evicted the fewest times can be selected for eviction. This can be distinguished from an LRU system where the eviction is based on usage when the line is in cache and not the number of times the line is needed and not stored in cache. The cache management/logging system disclosed herein can work in cooperation with an LFU algorithm or a LRU algorithm or other algorithm where these algorithms can utilize the directory of evicted cache line to help further reduce the cache miss rate and improve overall system performance.

In one embodiment, a method for cache management is disclosed. The method can assign or determined identifiers for lines of binary code that are, or will be, stored in cache. The method can create a cache eviction log that utilizes the identifier to keep an eviction count and/or a reload count lines that have been cached but are currently stored in system memory. Thus, each time a line is entered into, or evicted from cache, the cache eviction log can be amended. When a processor receives or creates an instruction that requests that a line of binary code be evicted from cache, the cache eviction log can initially identify a line or lines of binary code to be evicted based on data in the cache eviction log. Accordingly, the line(s) with no or low eviction counts can be evicted and the requested line(s) can be loaded.

In another cache eviction embodiment, a processor can evict the required number cache lines cache that have never been evicted, and if all lines in cache have been evicted in previous evictions and more cache capacity is needed, a ranking of lines of cache can be utilized to determine which lines to evict. The ranking can be based on the number of times that the line has been evicted from cache.

In yet another embodiment, a data processing system is disclosed that includes a processor, cache coupled to the processor and an eviction management module coupled to the processor. The eviction management module can assign an identifier to line(s) of code that are placed in cache or are evicted from cache. Alternately, the eviction management can utilizing an existing identifier or modify an existing identifier for lines of code that are placed in cache. Then, each time that a line of code is evicted, an eviction count of the identifier can be incremented in an eviction directory. If the eviction is a first eviction, the identifier can be added to the eviction directory and assigned a count of one (1).

In a specific embodiment, the eviction manager can assist the processor in keeping a “real-time ranking” of lines of code in cache, ranging from lines that have never been evicted to lines that have been frequently evicted. When the processor needs to cache lines and no cache is available or there is a cache conflict, the processor can make a decision regarding what lines to evict based on the contents of the eviction directory, often a line with a lowest rank. In a particular embodiment, an eviction candidate log can monitor lines placed into cache and lines evicted from cache and wherein a plurality of lines having an equal number of eviction counts are selected for eviction, then a least recently used LRU module can analyze the plurality of lines selected as having an equal number of evictions.

In yet another embodiment, a computer program product comprising a computer useable medium having a computer readable program is disclosed. In this embodiment the computer can assign identifiers to at least one line of binary code, where the at least one line of binary code to be stored in cache. The computer can also create a cache eviction log utilizing the identifier and the cache eviction log can store an eviction status of the at least one line of binary code. In addition the computer can receive at least one instruction at a processor during execution of a set of instructions wherein the at least one instruction facilitates that a line of binary code be evicted from the cache and the computer can identify a line of binary code to be evicted from the cache responsive to the cache eviction log.

In a particular embodiment the computer program product can evict the identified line of binary code and amend the cache eviction log in response to evicting the identified line of binary code. The computer can also keep a real-time inventory of lines in cache that have never been evicted such that no searching is required prior to eviction. The computer can indicate in the cache eviction log, a ranking of lines of cache based on the number of times that the line has been evicted from cache and can stores a number of times that the line of binary code has been reloaded and selected to be evicted from the cache is based on the number of times that the line of binary code has been reloaded.

In yet another embodiment, a design structure embodied in a machine readable storage medium for at least one of designing, manufacturing, and testing a design is provided. The design structure generally includes a processing system. The process system generally includes a processor, cache coupled to the processor to provide at least one line of binary storage to the processor module, an eviction management module coupled to the processor to monitor lines of code interacting with the cache and to count storage related occurrences of the lines of code with respect to the cache, the lines of code having an identifier, and a cache directory to store the count and the identifier, wherein if processor requests cache capacity, the cache directory provides eviction related data for a line of code stored in the cache to the processor.

### BRIEF DESCRIPTION OF THE DRAWINGS

Aspects of the invention will become apparent upon reading the following detailed description and upon reference to the accompanying drawings in which, like references may indicate similar elements:

FIG. 1 depicts a block diagram of a computer system with a cache eviction manager.

FIG. 2 illustrates a more detailed block diagram of a cache eviction manager.

FIG. 3 depicts a flow chart of a cache management method.

FIG. 4 illustrates another flow chart of a cache management method.

FIG. 5 is a flow diagram of a design process used in semiconductor design, manufacture, and/or test.

### DETAILED DESCRIPTION OF THE PREFERRED EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present invention may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

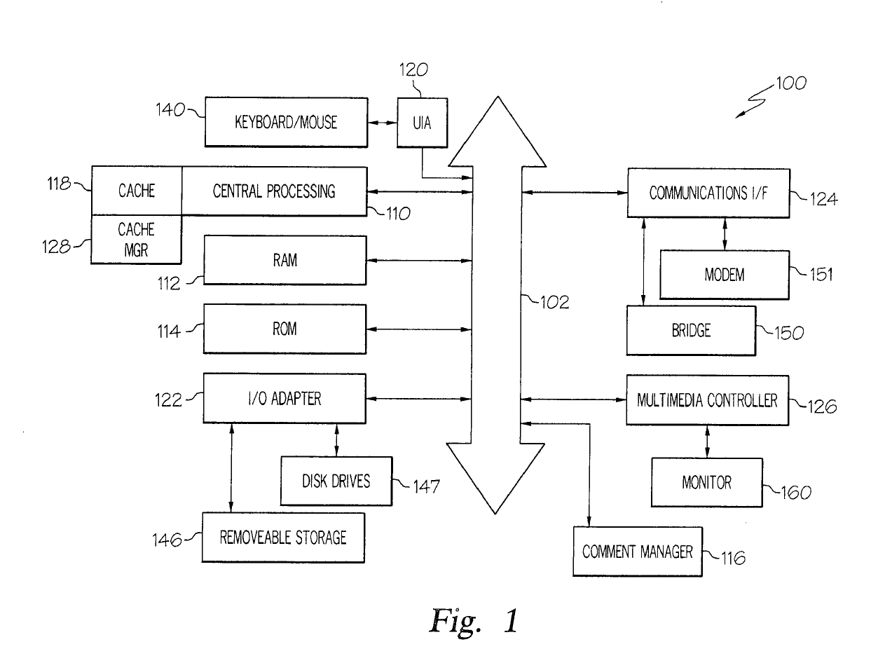

Turning now to the drawings, FIG. 1 illustrates, in a block diagram format, a processing device such as a personal computer system 100. The disclosed system 100 can evict lines in cache memory that, based on historical data, are less-likely to be utilized in the near future. The disclosed system can also retain lines in cache that are more likely to be needed by the processor in the near future such that a computing system can operate more efficiently. Generally, the personal computing system 100 is one of many systems that can implement the cache eviction/reload tracking routine disclosed herein.

The eviction management/cache management procedures disclosed herein can be implemented concurrently with the execution of computer code where the operating system can be executing tasks that are specific to computer applications while cache management functions operate in the background. Thus, the system 100 can execute an entire suite of software that runs on an operating system, and the system 100 can perform a multitude of processing tasks in accordance with the loaded software application(s). Although a personal computer platform will be described herein, workstations or mainframe and other configurations, operating systems or computing environments would not part from the scope of the disclosure.

The computer system 100 is illustrated to include a central processing unit 110, which may be a conventional proprietary data processor, and memory, including cache memory 118, random access memory 112, read only memory 114. The system 100 can further include a cache manager 128, an input output adapter 122, a user interface adapter (UIA) 120, a communications interface adapter 124, and a multimedia controller 126.

The input output (I/O) adapter 122 can be connected to, and control, disk drives 147, printer 145, removable storage devices 146, as well as other standard and proprietary I/O devices. The UIA 120 can be considered to be a specialized I/O adapter. The UIA 120 as illustrated is connected to a mouse 140, and a keyboard 141. In addition, the UIA 120 may be connected to other devices capable of providing various types of user control, such as touch screen devices (not shown).

The communications interface adapter 124 can be connected to a bridge 150 to bridge with a local or a wide area network, and a modem 151. By connecting the system bus 102 to various communication devices, external access to information can be obtained. The multimedia controller 126 will generally include a video graphics controller capable of displaying images upon the monitor 160, as well as providing audio to external components (not illustrated).

Generally, the cache management methods described herein can be executed by the cache manager 128 which can monitor the caching activities of the central processing unit 110 and activities associated with lines in cache 118 and provide such cache management. Cache management in accordance with the present disclosure can increase the efficiency of the central processing unit 110. The cache manager 128 could be integrated with the central processing unit 110 and/or implemented as a separate module internal to central processing unit 110. Alternately the central processing unit 110 can implement the disclosed method as a “housekeeping” procedure.

A cache line or line of cache is often defined as the smallest unit of data than can be transferred between cache 118 and the system memory (i.e. 112, 114, 147, and 146. However, the terms “cache lines”, “lines of cache,” “lines of code” or “lines” as utilized herein should be given a very broad meaning. These terms can be interpreted as the physical registers that make up cache memory or could be interpreted as the binary coded data that is stored in the physical registers. Accordingly, the registers in cache may store lines of code that are a binary sequence of instructions executable by the central processing unit 110, or the lines of code may represent raw data that is being processed by the central processing unit 110. Further, the term “lines” may refer to data that has already been altered or processed in some form and stored in cache. Thus, the term “lines” as utilized herein should be interpreted to also include any binary sequence that can be physically stored by a physical line of cache and any unit of physical storage that can store a binary unit.

Lines that are stored in cache lines can have an identifier or be assigned an identifier to track the treatment of such lines. In one embodiment, the identifier can be a memory address that performs a dual role. For example, the address can be a memory address where the line is stored in RAM 112, ROM 114, or possibly disk drives 147 or removable storage 146. Such a memory address could be utilized by the cache manager 128 to track treatment of the line in cache operations. The line of cache may be data that is duplicated from a line stored in non-cache memory (i.e. 112, 114, 147, and 146) that has been retrieved by the central processing unit 110. In accordance with the present disclosure, all of the above-mentioned components can be interconnected with a system bus such that the cache manager 128 can monitor the flow of requests from the central processing unit 110 to the main memory 212.

In operation, the central processing processor 110 can request or require data or an instruction to be cached, and an identifier associated with the requested line of cache can be compared to identifiers of lines residing in cache 118. The number of times that a particular line is requested by the central processing unit 110, and/or loaded into cache 118, and the number of times that the line is evicted from cache 118 can be counted and stored by the cache manager 128. If the requested line(s) cannot be located in cache 118, and the cache 118 is full or does not have enough capacity to store the amount of requested lines, the cache manager 128 can evict or flush a line in cache with the least reload/eviction count to make room for the new request. Accordingly, lines in cache 118 that have been evicted and reloaded the most times can stay in cache 118, while less frequently evicted and reloaded cache line can be evicted. Thus, the cache manager 128 can store a list or organize stored identifiers from the most commonly evicted cache line identifiers or addresses to the least commonly evicted identifiers. When eviction is required the cache manager 128 can refrain from evicting the lines with a high eviction count and evict the least frequently evicted and reloaded lines

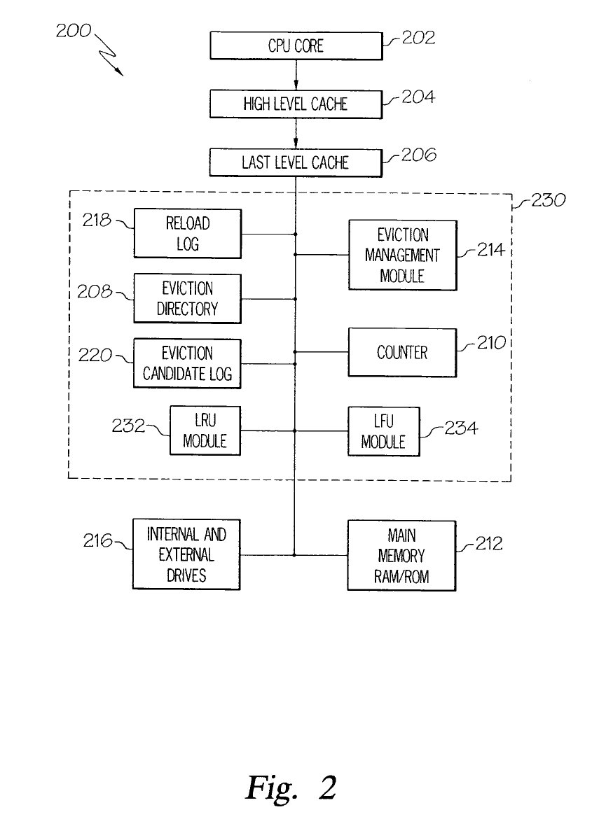

Referring to FIG. 2, a block diagram of an embodiment of a portion of a computer system 200 that includes cache management components 230 in the dashed box is depicted. The cache management components 230 can function similar to, the cache manager 128 illustrated in FIG. 1. The cache management components 230 can include eviction manager module 214, counter 210, eviction candidate log 214, eviction directory 208, LRU module 232, LFU module 234, and reload log 218. In one embodiment, the reload log 218, the eviction directory 208, and the eviction candidate log 214 can be implemented as erasable dynamic random access memory (EDRAM).

The computer system 200 can include a processing unit such as CPU core 202, high level cache 204, last level cache 206, (herein referred to as cache 204/206), internal and external and main memory 212. Main memory 212 could be implemented as random access memory (RAM) and/or read only memory (ROM). The main and the can contain or store a suite of software tools commonly bundled to form, at least part of an operating system. The main memory 212 and drives 216 can also contain specialized applications that can run under the control of the operating system.

In operation, when the CPU core 202 requires data or instructions in the form of a line of cache, the CPU core 202 can look to see if the required line is in cache 204/206, and if the line is not found in cache 204/206, the CPU core 202 can create instructions to fetch the line from main memory 212 or from drives 216 and place the line(s) in cache 204/206. If the cache 204/206 is full, then the eviction manager module 214 can determine or select which line or lines in cache 204/206 will be evicted. In another embodiment the CPU core 202 may perform the eviction by itself, or give instructions to the eviction manager module 214 to evict or flush at least one line from cache 204/206 and the eviction manager module 214 can execute such commands.

Often, numerous lines of cache must be evicted when the CPU core 202 starts a new process or loads new software because often, a new set of code or instructions will require different code and data in cache than the previous process. Thus, cache 204/206 can have a large change in content when such a transition occurs and lines which have low or lower eviction counts could be evicted and a new eviction session could be started. A session can be a defined as a time period starting when the CPU core 202 was powered up and lasting until the CPU is powered down or it could be a time period starting when a particular piece of software or subroutine is loaded and executed or further it could be a time duration that a particular loop in the software.

A session could also be defined dynamically based on specific or general phenomena by the eviction manager module 214 or the CPU core 202 including an execution of a software module, a subroutines, cache hit rates, and cache miss rates. Accordingly, the eviction manager module 214 may start a new session and make instructions to evict numerous lines in cache 204/206 to make room for a new processing session.

In one embodiment, after the CPU core 202 requests the eviction manager module 214 to free up some cache, and the CPU core 202 identifies what lines in main memory 212 and drives 216 needs to be fetched and placed in cache 204/206, the eviction manager module 214 can determined if the requested line(s), or the line(s) to be placed into cache, has been previously evicted in a session by referring to the eviction directory 208. The line that is requested by the CPU core 202 and that the CPU core 202 will be caching, can have an identifier or be assigned an identifier.

The identifier can be an address that indicates where the line resides in memory. Thus, the identifier can be the same address utilized by the system 200 for communicating where the line is stored and/or retrieved in main or internal and external drives 216. In another embodiment, the address can be a reduced, compressed or abbreviated version of the actual address or can be a specialize tag that is linked to the actual memory address of the line. When a line of cache gets evicted, the eviction manager module 214 can facilitate entry of the line identifier into the eviction directory 208. Alternately, when the identifier is already present in the eviction directory 208 and an eviction occurs, an eviction count for the identifier can be incremented by the counter 210 or the eviction manager module 214 such that each eviction occurrence can be counted.

In one embodiment, when the eviction manager module 214 receives a request to evict at least one line from cache 204/206, the eviction manager module 214 can select a line or a group of lines in cache 204/204 for eviction analysis. In this embodiment, the identity of the line selected for analysis can be utilized by the eviction manager module 214 to retrieve or acquire an eviction count of the line from the eviction directory 208. When the eviction management module 214 determines that the selected line(s) has previously been evicted one or more times in the current session, the eviction management module 214 may select another line or group of lines for analysis.

In another embodiment, a real-time ranking of the lines in cache can be achieved where the eviction candidate log 220 organizes the identifiers in order of how many times a line as been evicted. Thus, the eviction manager module 214 can make entries into the eviction directory 208 or store identifiers in the eviction directory 208 in order of their rank (i.e. a high rank equals a high number of evictions). The eviction manager module 214 can also analyze lines in cache 204/206 and determine that some lines in cache 204 and 206 have not been evicted in the current session.

In yet another embodiment, the eviction candidate log can be a portion of the eviction directory that log lines that have never been evicted or reloaded or have been evicted and reloaded only a few times. When the CPU core 202 requires five lines of cache to be freed up, these five lines can be quickly located by accessing the eviction candidate log 220.

In another embodiment, the eviction management module 214 may place identifiers of lines under analysis in eviction candidate log 220 and tag the identifier having no or few evictions. When the evictions management module 214 selects another line and determines that the line selected for analysis also has a predetermined number of evictions, the evictions management module 214 may not place the identifier in the eviction candidate log 220. If the eviction candidate log 220 is full or is storing a quantity of lines required for flushing additional lines can be analyzed and newly analyzed lines with higher eviction counts may “bump” lines out of cache 204/206 with lower eviction counts. The eviction candidate log 220 can be updated during every clock cycle that manipulates the contents of cache 204/206 such that good, but not necessarily the best eviction candidates can be readily identified for eviction when free cache is needed by the CPU core 202.

In other embodiments, a candidate log is not necessary and, the CPU core 202 or the eviction management module can utilize entries in the cache eviction directory 208 to detect a history of evictions and evict a lines in cache 204/206 based on this historical data. The eviction candidate log 220 can reveal which lines in cache have never been evicted, lines that are rarely evicted and lines that are often evicted and the CPU core 202 can make an eviction decision in real time based on the contents of the eviction directory 208.

In one embodiment, all lines of cache can be searched prior to identifying which lines will be evicted such that the lines in cache with the lowest number of eviction can be flushed and in other embodiments when an acceptable number of acceptable eviction counts are located in the search and eviction process can end. When there are multiple candidates for eviction that have not previously been evicted, the eviction management module 214 can activate the least frequently used (LFU) module 234 or the least recently used (LRU) module 232. Accordingly, the LFU module 234 and/or the LRU module 232 can chose a line for eviction from the eviction directory 208 or just from lines in cache 204/206 without regard from the logged eviction data. The LFU module 234 can select a line to be evicted or flushed is the least frequently used and the LRU module 234 can select a line to be evicted from cache 204/206 when it has been used (read or written) less recently than any other line.

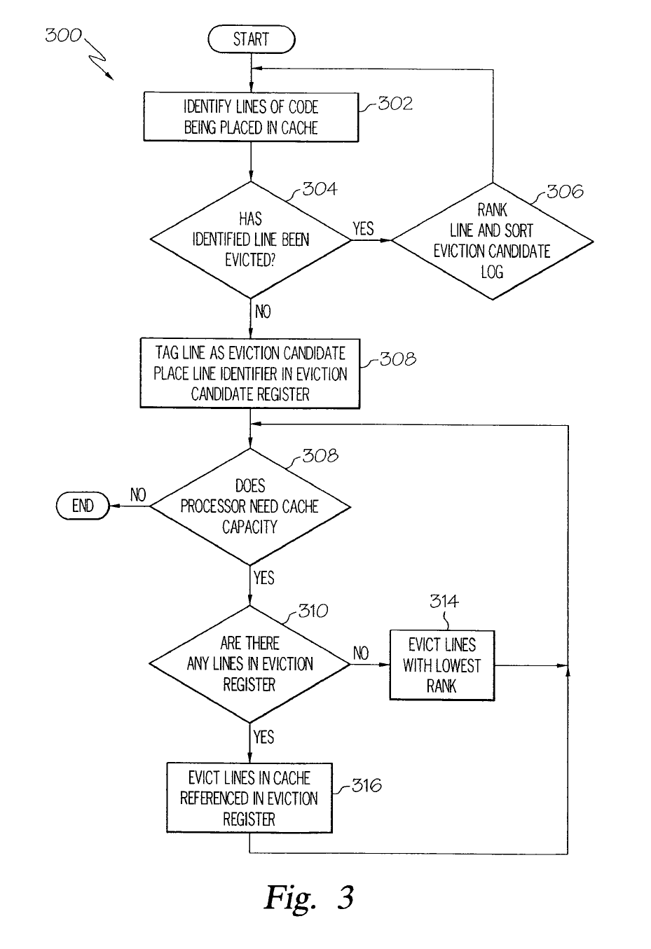

Referring to FIG. 3 a method for improved cache management is disclosed. As illustrated in block 302, a cache management module can identify lines of code that are being placed in cache. Responsive to lines of code being placed cache it can be determined if the identified lines have been previously evicted, as illustrated by decision block 304. If the identified lines have been previously evicted then, as illustrated by block 306, the rank of the identified line can be changed and an eviction candidate log can be sorted or indexed such that the lines with more evictions have a higher rank than the lines with less evictions.

When at decision block 304 it is determined that the identified line or the line to be loaded into cache has never been evicted, then the line can be tagged as an eviction candidate and in one embodiment placed in one of an eviction candidate register, as illustrated in block 308. Thus, the eviction candidate log can have registers that are reserved to store or identify all lines stored in cache that have never been evicted such that these candidates can be quickly acquired. As illustrated in decision block 310, it can be determined if the processor needs capacity in cache. When it is determined that no additional lines are needed at decision block 310, the process can end, however, if the processor needs cache capacity then, as illustrated by decision block 312, it can be determined if there are any lines stored in the eviction register.

If there are no lines of cache in the eviction register then the processor can evict lines with the lowest rank in an eviction directory as illustrated by block 314. In an alternate embodiment, block 314 could implement a LRU of LFU routine. In the embodiment disclosed in the flow diagram 300, if there are no lines present in the eviction register(s) at decision block 312, then lines in cache can be evicted that have a lowest ranking as illustrated in block 314 and the process can revert to block 310 where again it can be determined if the processor needs cache capacity.

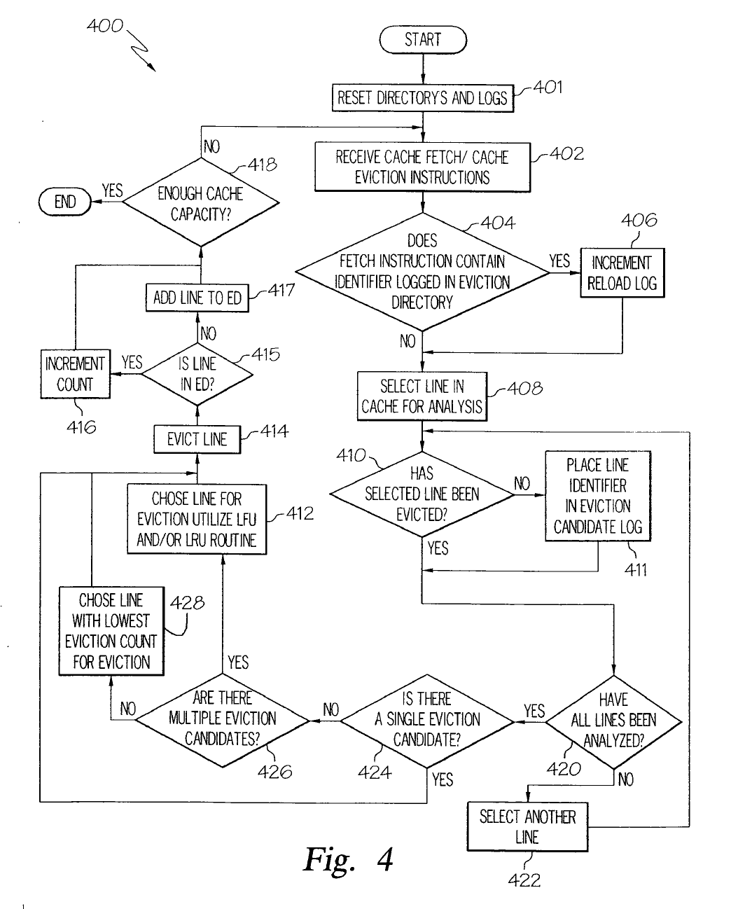

Referring to FIG. 4, a flow chart 400 illustrating a method for managing cache is depicted. To achieve a greater operational efficiency, the disclosed method can evict lines in cache that are less-likely to be utilized in the near future and retain lines in cache that are more likely to be needed in the near future such that a computing system or processor can operate more efficiently. This selective cache eviction process can start by resetting or setting all logs, directories and counters to zero to start a session as illustrated by block 401. A processor can receive an instruction to fetch a line and place it in cache, or to evict at least one line of cache, as illustrated by block 402.

This will typically occur when a processor needs a line in cache to store a binary sequence and there is a cache capacity conflict. When the processor requests a line to be cached and the cache is at capacity, or there is no available cache, a line must be deleted from cache or evicted from cache. The requested binary line can have an identifier such as a tag or an address.

As illustrated by decision block 404, it can be determined if the line to be placed into cache has been previously evicted in the session by referring to a cache eviction log. This can be accomplished by comparing the identifier of the requested line with identifiers present in the cache eviction log. If the requested line has been logged in the cache eviction directory a reload log for the requested line can be created or incremented for the requested line as illustrated by block 406. A line that currently resides in cache can be selected for eviction analysis as illustrated by block 408. Then, it can be determined by referring to a cache eviction directory, if the selected line has previously been evicted in the current session, as illustrated by decision block 410.

If the selected line has not been evicted in the current session, then the selected line can be identified as an eviction candidate and placed in an eviction candidate log as illustrated by block 411. If the selected line as been evicted as in decision block 410 or if the selected line has been placed in the eviction candidate log as in block 411, the process can determine if all lines in cache have been analyzed, as illustrated by decision block 420. If all cache lines have not been analyzed then another line currently in cache can be selected for analysis as illustrated in block 422 and the process can revert to block 410.

When all lines in cache have been analyzed at decision block 420, it can be determined if there is a single eviction candidate as illustrated in decision block 424 If there is a single eviction candidate in the eviction candidate log, the process can move to block 414 where the single eviction candidate can be evicted. When, at decision block 424 it is determined that there is not a single eviction candidate then, as in decision block 426 it can be determine if there are multiple eviction candidates or more than one line in cache that have never been evicted.

When there are multiple candidates for eviction that have not previously been evicted, the process can proceed to a least frequently used (LFU) routine or a least recently used (LRU) routine and the LFU and/or the LRU routine can chose a line for eviction from the eviction candidate list as depicted by block 412. The LFU routine can select a line to be evicted or flushed is the least frequently used. The LRU routine can select a line to be evicted when it has been used (read or written) less recently than any other line as described above.

When, as illustrated by decision block 426, when there are not multiple eviction candidates, or every line in cache has been logged in the eviction directory then, as illustrated in block 428, the line with the lowest eviction count in the eviction directory can be selected for eviction. As illustrated in block 414, after a line has been selected for eviction as in blocks 412, 424 or 428 then the line can be evicted as illustrated in block 414.

As illustrated by decision block 415, if the evicted line is in the eviction directory then the eviction count can be incremented as illustrated in block 416. Alternately, if the evicted line is not in the eviction directory then a line can be added to the eviction directory as illustrated in block 417. It can then be determined if there is enough capacity in cache as illustrated in block 418. If there is enough cache capacity, the process can end and if there is not enough cache capacity the process can revert to block 402 and the process can reiterate.

Many variations could be made to the illustrated process. For example, at block 410 when analyzing a first selected line if it is determined that this line which resides in cache have not been logged in the eviction directory the process could immediately move to block 414 and evict the selected line, and only one line would have to be analyzed to free up the required line of cache. In another embodiment, at block 410 when analyzing a first block, of say five selected lines, if it is determined that one, or some of these lines which resides in cache have not been logged in the eviction directory the process could immediately move to block 412 where these eviction candidate(s) can are processed by the LRU-LFU routines illustrated by block 412.

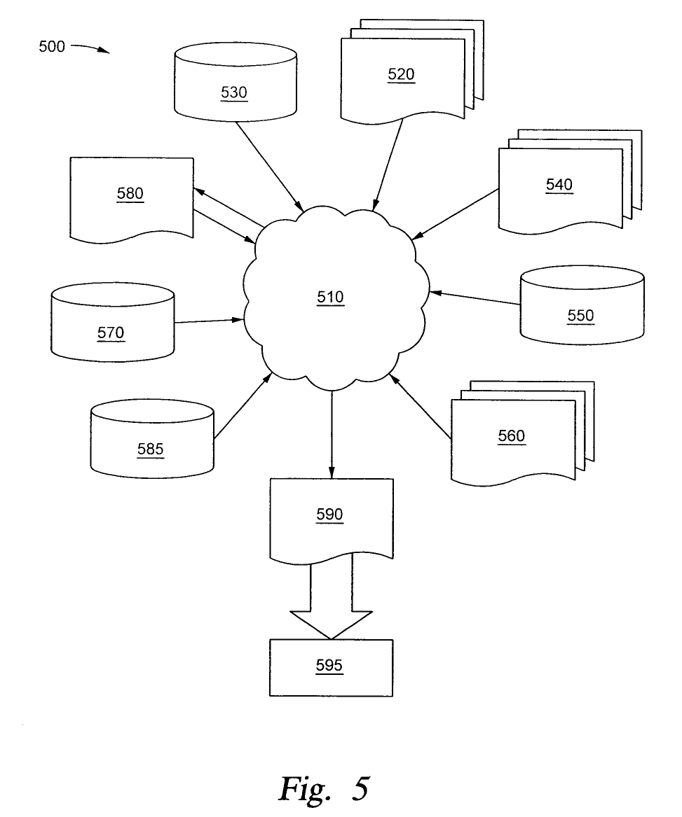

FIG. 5 shows a block diagram of an exemplary design flow 500 used for example, in semiconductor design, manufacturing, and/or test. Design flow 500 may vary depending on the type of IC being designed. For example, a design flow 500 for building an application specific IC (ASIC) may differ from a design flow 500 for designing a standard component. Design structure 520 is preferably an input to a design process 510 and may come from an IP provider, a core developer, or other design company or may be generated by the operator of the design flow, or from other sources. Design structure 520 comprises the circuits described above and shown in FIGS. 1 and 2 in the form of schematics or HDL, a hardware-description language (e.g., Verilog, VHDL, C, etc.). Design structure 520 may be contained on one or more machine readable medium. For example, design structure 520 may be a text file or a graphical representation of a circuit as described above and shown in FIGS. 1 and 2. Design process 510 preferably synthesizes (or translates) the circuit described above and shown in FIGS. 1 and 2 into a netlist 580, where netlist 580 is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist 580 is resynthesized one or more times depending on design specifications and parameters for the circuit.

Design process 510 may include using a variety of inputs; for example, inputs from library elements 530 which may house a set of commonly used elements, circuits, and devices, including models, layouts, and symbolic representations, for a given manufacturing technology (e.g., different technology nodes, 32 nm, 45 nm, 90 nm, etc.), design specifications 540, characterization data 550, verification data 560, design rules 570, and test data files 585 (which may include test patterns and other testing information). Design process 510 may further include, for example, standard circuit design processes such as timing analysis, verification, design rule checking, place and route operations, etc. One of ordinary skill in the art of integrated circuit design can appreciate the extent of possible electronic design automation tools and applications used in design process 510 without deviating from the scope and spirit of the invention. The design structure of the invention is not limited to any specific design flow.

Design process 510 preferably translates a circuit as described above and shown in FIGS. 1 and 2, along with any additional integrated circuit design or data (if applicable), into a second design structure 590. Design structure 590 resides on a storage medium in a data format used for the exchange of layout data of integrated circuits (e.g. information stored in a GDSII (GDS2), GL1, OASIS, or any other suitable format for storing such design structures). Design structure 590 may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIGS. 1 and 2. Design structure 590 may then proceed to a stage 595 where, for example, design structure 590: proceeds to tape-out, is released to manufacturing, is released to a mask house, is sent to another design house, is sent back to the customer, etc.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present invention, represent embodiments of the present disclosure.

The disclosed embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods, systems, and media that provide cache management. It is understood that the form of the invention shown and described in the detailed description and the drawings are to be taken merely as examples. It is intended that the following claims be interpreted broadly to embrace all the variations of the example embodiments disclosed.

What is claimed is:

1. A design structure embodied in a machine readable storage medium for at least one of designing, manufacturing, and testing a design, the design structure comprising:
a processing system, comprising:
a processor;
cache coupled to the processor to provide at least one line of binary storage to the processor module;
an eviction management module coupled to the processor to monitor lines of code interacting with the cache and to count storage related occurrences of the lines of code with respect to the cache, the lines of code having an identifier; and
a cache directory to store the count and the identifier, wherein if processor requests cache capacity, the cache directory provides eviction related data for a line of code stored in the cache to the processor.

2. The design structure of claim 1, further comprising:
a least recently used module to evaluate contents of the cache directory.

3. The design structure of claim 1 further comprising:
a least frequently used module to evaluate contents of the cache directory.

4. The design structure of claim 1, wherein the storage related occurrences are eviction occurrences.

5. The design structure of claim 1, wherein the storage related occurrences are reload occurrences.

6. The design structure of claim 1, wherein the design structure comprises a netlist which describes the processing system.

7. The design structure of claim 1, wherein the design structure resides on the machine readable storage medium as a data format used for the exchange of layout data of integrated circuits.
